(19) United States
(12) Patent Application Publication
(10) Pub. No.: US 2005/0274584 A1
(43) Pub. Date: Dec. 15, 2005

(54) Deformation Element for a Vehicle Dashboard

(75) Inventor: Bradley James Baxter, Bloomfield Hills, MI (US)

Correspondence Address: HOLLAND & HART, LLP, 555 17TH STREET, SUITE 3200, DENVER, CO, 80201, US

(73) Assignee: Intensa Inc., Pontiac, MI (US)

(21) Appl. No.: 10/709,743

(22) Filed: May 26, 2004

(51) Int. Cl. F16F 7/12

(52) U.S. Cl. 188/371

(57) ABSTRACT

A deformation element for use in a motor vehicle dashboard includes first and second slidably interlocked deformation members. The deformation element includes first and second deformation cavities which may deform in sequential stages, or concurrently, upon the application of a load along a deformation axis of the deformation member. The first and second deformation members may be formed from stamped steel and have substantially identical shapes, requiring only one stamping form.

### FIELD OF THE INVENTION

The present invention relates to energy absorbing structures, and, more specifically, to an energy absorbing deformation element for a motor vehicle dashboard.

### BACKGROUND OF THE INVENTION

Present day passenger motor vehicles include a number of advanced safety features designed to help protect and/or reduce injury to vehicle occupants in the event of a collision or upset of the vehicle. One such safety feature is known as a knee blocker. Typically, a vehicle includes a knee bolster panel which is associated with a dashboard and instrument panel within a vehicle passenger compartment. A knee blocker is installed in an automobile between the knee bolster panel and a cross member which extends transversely to the longitudinal vehicle direction along the width of the dash/instrument panel area. The cross member is connected to a vehicle support structure. Such a basic arrangement of a knee bolster, knee blocker, and cross member within a vehicle, as well as relative to a vehicle body support structure in a passenger vehicle is well known. In the event of a collision, if a front seat vehicle occupant is not belted, the knee blocker absorbs at least part of the kinetic energy of the unbelted occupant's body and knees in order to help reduce injury to the occupant.

In the United States, vehicles are required to have such energy absorbing knee blockers to help reduce injury to unbelted drivers and passengers in the event of a collision. However, several other countries, including many European countries, have no such requirements because vehicle occupants are assumed to be belted. In the United States, specific force versus displacement characteristics are required for knee blockers. Present day knee blockers having the best performance are aluminum alloy extruded brackets. The way in which these brackets crush and absorb impact energy is predictable and repeatable, which is important for an accurate and quick product development cycle, as they require significantly less trial, error, and testing cycles as compared with other types of knee blockers. However, such extruded aluminum brackets are relatively expensive, and are thus not favored for high volume vehicle manufacture.

In order to help reduce cost, many manufacturers use less expensive steel knee blockers. Many of these steel knee blockers are made in the shape of an “S,” or the bracket may simply be a box-shaped stamping commonly referred to as “pork chop” brackets. These steel brackets weigh more than aluminum brackets due to the difference in material, but are selected because of the reduced manufacturing cost. However, such brackets generally do not use an optimized geometry, and therefore performance of the brackets during impact is not as predictable or repeatable as extruded aluminum brackets. A main reason that an optimized geometry is not easily achieved is that in order to mimic an aluminum bracket geometry, the steel would have to be extruded, which is not generally feasible while maintaining a relatively low cost. Such brackets are therefore commonly stamped or drawn in one piece, which does not generally result in an optimal geometry.

Accordingly, it would be beneficial to have an inexpensive knee blocker which may formed from non-extruded parts which are inexpensive to manufacture and have reduced material costs compared to aluminum. Furthermore, it would be advantageous for such knee blockers to have repeatable and predictable performance, thus reducing development costs by providing an accurate and quick product development cycle.

### SUMMARY OF THE INVENTION

The present invention provides a deformation element for use in a vehicle passenger compartment which is inexpensive to manufacture and assemble, and has a reliable and predictable performance.

One aspect of the present invention provides an energy absorbing structure assembled from a first deformation member having a double curved shape with first and second opposing radii of curvature in the direction of a deformation axis, and a second deformation member having a substantially identical shape as the first deformation member. The first and second deformation members are interconnected such that the first and second deformation members intersect to define first and second deformation cavities between the deformation members. Upon the application of a load in the direction of the deformation axis, at least one of the deformation cavities becomes closed, absorbing energy from the load. The deformation members include a plurality of engagement slots. The engagement slots of each deformation member slidably engage with engagement slots of the other deformation member allowing the deformation members to substantially completely overlap.

In another aspect of the invention, a two stage deformation element is provided, where the first deformation cavity is operable to close upon the application of a first load in the direction of the deformation axis, and both the first and second deformation cavities are operable to close upon the application of a second load in the direction of the deformation axis, wherein the second load is greater than the first load. In one embodiment, the first and second deformation members include a first flange along the first radius of curvature and a second flange along the second radius of curvature. A height of the first flange is greater than a height of the second flange, resulting in the deformation cavity associated with the first flange requiring a larger load in order to collapse. The height of the first and second flanges may be selected based on load requirements for the deformation element.

The foregoing and other features, utilities and advantages of the invention will be apparent from the following more particular description of a preferred embodiment of the invention as illustrated in the accompanying drawings.

### BRIEF DESCRIPTION OF THE DRAWINGS

FIG. 1 is a perspective illustration of a deformation element of an embodiment of the present invention;

FIG. 2 is an exploded perspective illustration of the engagement of first and second deformation members according to an embodiment of the present invention;

FIG. 3 is a cross section illustration of a deformation member of an embodiment of the present invention;

FIG. 4 is a cross section illustration of a deformation element of an embodiment of the present invention;

FIG. 5 is a side elevation view of a deformation element of an embodiment of the present invention;

FIG. 6 is a cross section illustration of a lever arm of a deformation member taken along section C-C of FIG. 5;

FIG. 7 is a cross section illustration of a lever arm of a deformation member taken along section B-B of FIG. 5;

FIG. 8 is a cross section illustration of a deformation element of another embodiment of the present invention; and

FIG. 9 is a cross section illustration of a four-member deformation element of another embodiment of the present invention.

### DETAILED DESCRIPTION

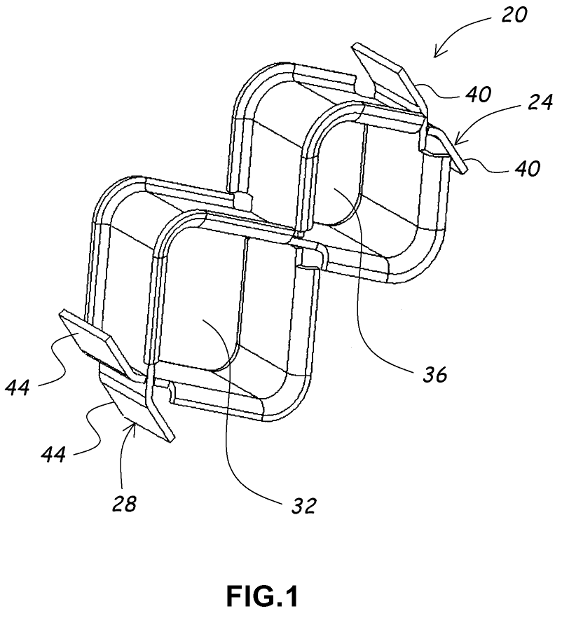

A deformation element, according to an embodiment of the invention as illustrated in FIGS. 1-7, is integrated as a knee blocker into a passenger vehicle. A knee bolster, as described above, is associated with the knee blocker and located generally beneath a dashboard/instrument panel in the passenger area of a vehicle. Because the basic arrangement of a knee bolster, knee blocker, and cross member within a vehicle, as well as relative to a vehicle body support structure, is known, the drawings do not illustrate any details in this respect.

Referring to FIG. 1, a deformation element of an embodiment of the present invention is described. The deformation element 20 has a first end 24 and a second end 28. Between the first end 24 and second end 28 is a first deformation cavity 32 and a second deformation cavity 36. The first end 24 of the deformation element 20, in an embodiment, is attached to a cross member (not shown) within a passenger vehicle, and the second end 28 is mounted to a knee bolster (not shown). As is well understood in the art, a knee bolster is generally arranged to transmit force applied to one or more areas of the knee bolster to underlying components supporting the knee bolster, in the present example, one or more deformation elements. In the event of a vehicle collision, if a vehicle occupant hits the knee bolster, the force of the impact will be transmitted to the deformation element(s) 20. The function of the deformation element(s) 20 in such a case is to absorb the kinetic energy of the vehicle occupant, and will be described in more detail below. While this embodiment is described with respect to a knee blocker, it will be understood that numerous other applications are available for such a deformation element, including, for example, use in a vehicle bumper assembly to absorb energy from a vehicle collision, use in a seat belt assembly to reduce the amount of force between a seat belt and a vehicle occupant in the event of a vehicle collision, and in military applications to reduce the impact force on a supply container when dropping such a container from an aircraft.

The deformation element 20 has mounting flanges 40 located at the first end 24, and mounting flanges 44 located at the second end. The mounting flanges 40, 44 are used to secure the deformation element 20 to the cross member, and the knee bolster to the deformation element 20, respectively. The mounting flanges 40, 44 may have holes to facilitate mounting with hardware such as a bolt, or may have a continuous surface for securement using adhesives, welds, or any other appropriate securement methods. In one embodiment, the mounting flanges 40, 44 have a preselected size suitable for engagement with a corresponding cavity or slot on a knee bolster or cross member. In this manner, the deformation element 20 may be secured by slidably engaging the mounting flanges to the appropriate slots. The orientation of the mounting flanges 40, 44 relative to the deformation element may be adjusted as required for a specific application.

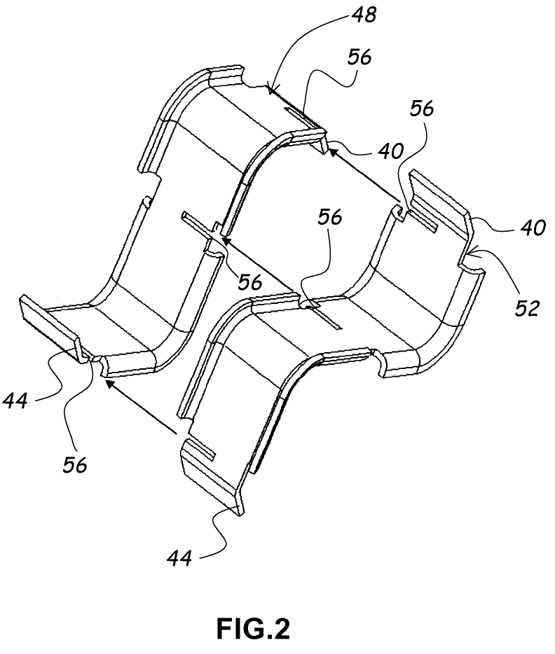

Referring now to FIG. 2, the deformation element 20 is formed from a first deformation member 48, and a second deformation member 52. The first and second deformation members 48, 52 have substantially identical shapes with a double curve structure. Each of the first and second deformation members 48, 52 has several engagement slots 56 which extend approximately half of the width of the deformation members 48, 52. When the deformation members 48, 52 are arranged such that the curves oppose one another, the engagement slots 56 may be aligned, as illustrated in FIG. 2. The first deformation member 48 and second deformation member 52 may be slidably engaged such that the engagement slots 56 engage with one another and the deformation members 48, 52 form the deformation element 20. When the first and second deformation members 48, 52 are engaged, they substantially completely overlap to form the deformation element. In one embodiment, the deformation members 48, 52 are secured after engagement with a spot weld, crimp, or clip to help ensure that the deformation members 48, 52 remain connected during shipment of the deformation element, or in the case where attachment methods in the vehicle do not fix in place both deformation members. Additionally, in an embodiment, the engagement slots 56 are positioned such that one of the deformation members 48, 52 must be slightly compressed in order to slidably engage the other deformation member, thus creating tension or compression forces between the members which may be desirable in order to keep the members from easily sliding apart.

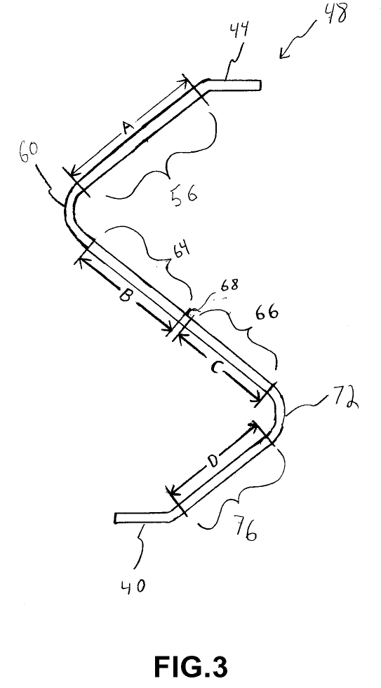

With reference now to FIG. 3, a cross-sectional illustration of the first deformation element 48 is now described. As mentioned above, the first and second deformation members 48, 52 have substantially identical shapes, and the description of the first deformation member 48 also applies to the second deformation member 52. The first deformation member 48, as mentioned previously, has a mounting flange 44, which is connected to an upper lever arm 56. The upper lever arm 56 joins with an upper curve 60. The upper curve 60 is in turn connected to an upper middle lever arm 64. The upper middle lever arm 64 is connected to a lower middle lever arm 66. The upper middle lever arm 64, and lower middle lever arm 66 are divided at midpoint 68, which also corresponds to a point where an engagement slot 56 is formed in the deformation member 48. The lower middle lever arm 66 connects to a lower curve 72, and then to a lower lever arm 76. The lower lever arm 76 is then connected to mounting flange 40. In the embodiment illustrated, each of the lever arms is designed to have a specified length, with upper lever arm 56 having a length A, the upper middle lever arm having a length B, the lower middle lever arm having a length C, and the lower lever arm having a length D. In this embodiment, the lengths A and B are approximately equal, and the lengths C and D are approximately equal, with A being larger than C. However, it will be understood that each of the various lever arms may have a length relative to the other lever arms which is different than illustrated in FIG. 3, depending upon the application and deformation characteristics required. Engagement slots, not shown in the illustration of FIG. 3, are located at midpoint 68, near the top of the upper lever arm 56 adjacent to mounting flange 44, and near the bottom of the lower lever arm 76 adjacent to mounting flange 40. More or less slots located in these or other positions are possible.

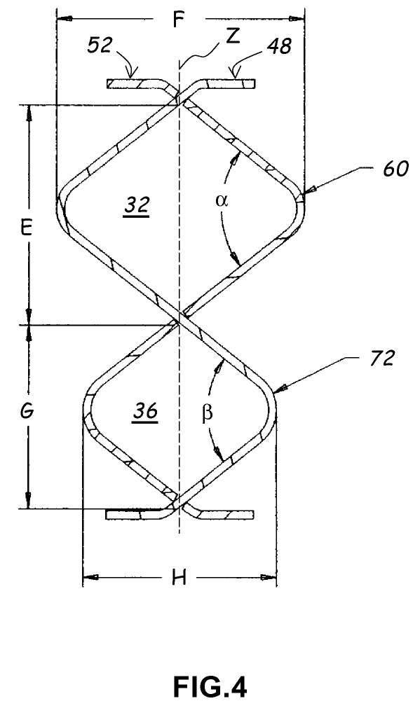

Referring now to FIG. 4, a cross section of the deformation element 20 is now described. The deformation element 20, as mentioned previously, is assembled from two deformation members 48, 52 having a substantially identical shape and which are arranged in an opposing relationship to form the first and second deformation cavities 32, 36. The deformation element 20 has a deformation axis Z, along which the first and second deformation cavities 32, 36 will collapse upon the application of a sufficient load in the direction of the deformation axis Z. As described with reference to FIG. 3, the lengths A and B are approximately equal, and the lengths C and D are approximately equal. This arrangement provides, when the first deformation member 48 is engaged with the second deformation member 52, the first deformation cavity 32 and the second deformation cavity 36. The first deformation cavity 32 has a generally diamond shape having a height E and a width F. Similarly, the second deformation cavity 36 has a generally diamond shape having a height G and a width H. As mentioned above with reference to FIG. 3, in this embodiment, the length A is greater than the length C, resulting in the first deformation cavity 32 being larger than the second deformation cavity 36. In this embodiment, the angle between the upper lever arm 56 and the middle lever arm 64 is designated as α, and the angle between the middle lever arm 64 and the lower lever arm 76 is designated as β. In the embodiment illustrated, the angles α and β are substantially equal. Thus, the length E is greater than the length G, and the length F is greater than the length H. As a result, the upper curve 60 has a radius of curvature which is smaller than the radius of curvature of the lower curve 72. As will be understood, the relative lengths of the various lever arms may be adjusted to accommodate required deformation characteristics which may result in different relative sizes of the first and second deformation cavities.

With the deformation members 48, 52 manufactured in such a manner, and the deformation element 20 assembled from the deformation members, several important characteristics are now described. The first deformation cavity 32, upon the application of a load in the direction of the deformation axis Z will collapse before the second deformation cavity 36. This results from the upper lever arms 56 and upper middle lever arms 64, having a longer length than the lower lever arms 76, and the lower middle lever arms. The increased length of the upper lever arms 56 results in a longer lever arm applying force to the upper curve 60. Furthermore, as described above, the radius of curvature for the upper curve 60 is smaller than the radius of curvature of the lower curve 72, creating the upper deformation cavity 32 which will collapse before the lower deformation cavity 36. The lower deformation cavity 36, relative to the upper deformation cavity 32, has both shorter lever arms and a larger radius of curvature for the lower curve 72. Thus, in order to collapse both the first and second deformation cavities 32, 36, a greater load is required than to collapse only the first deformation cavity 32. Thus, the deformation element 20 of this embodiment will collapse in two stages upon the application of a sufficient load in the direction of the deformation axis Z. The first deformation cavity 32 will collapse initially, and if a sufficient load is applied, the second deformation cavity 36 will also collapse. In one embodiment, the dimensions of the first deformation cavity 32 are selected such that it will collapse upon the application of a load which will be applied by a vehicle occupant having a relatively small weight, such as a 5th percentile adult. The dimensions of the second deformation cavity 36 are selected such that, after the first deformation cavity 32 collapses, the second deformation cavity 36 will collapse only upon the application of a load which would typically be applied by a vehicle occupant having a relatively large weight, such as a 95th percentile adult.

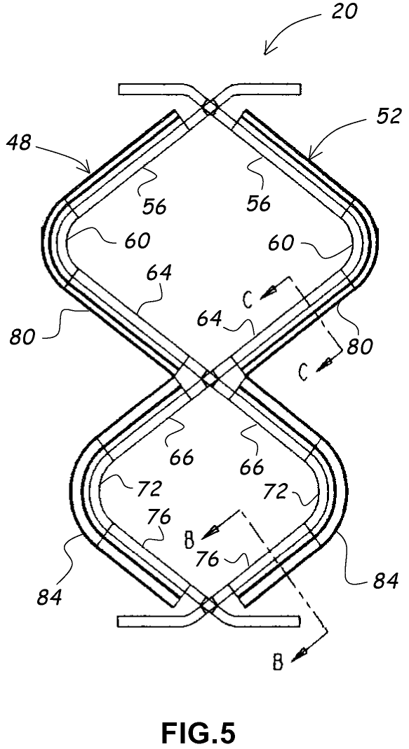

Referring now to FIG. 5, a side elevation view of the deformation element 20 is illustrated. The deformation element 20, as described above, is formed by slidably interlocking the first deformation member 48, and the second deformation member 52. In one embodiment, each deformation member 48, 52 is formed from a stamped piece of steel which is zinc pre-plated 80KSI steel. It will be readily understood by one of skill in the art that any number of different types of steel, and different materials altogether, may be used to form the deformation members 48, 52. In this embodiment, each deformation member 48, 52 also has an upper flange 80 extending along each side of the upper lever arm 56, first curve 60, and upper middle lever arm 64. Furthermore, a lower flange 84 extending along each side of the lower middle lever arm 66, second curve 72, and the lower lever arm 76. The upper flange 80 extends in an opposite direction as the lower flange 84, in order to have the flanges 80, 84 extend outwardly from the deformation element 20 when the first and second deformation members 48, 52 are interlocked. In other embodiments, the deformation element 20 may not have any flanges, may have flanges only associated with one of the deformation cavities, or may have flanges associated with only one of the deformation members.

In one embodiment, the width of the upper lever arm 56, first curve 60, and upper middle lever arm 64 is selected to be smaller than the width of the lower middle lever arm 66, second curve 72, and the lower lever arm 76. In this fashion, when the deformation cavities 32, 36 collapse, the upper middle lever arm 64 will nest within the lower middle lever arm 66.

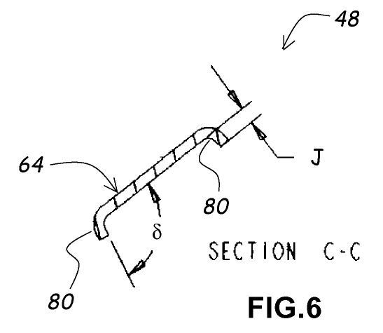

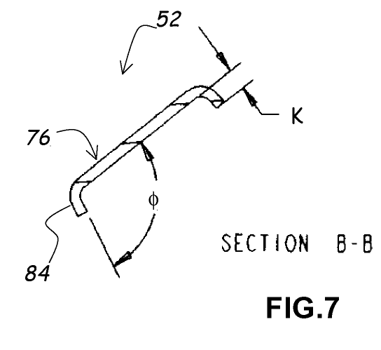

FIGS. 6 and 7 illustrate cross sections of the deformation members. FIG. 6 is a cross-sectional illustration taken along section C-C of the upper middle lever arm 64 of FIG. 5. FIG. 7 is a cross-sectional illustration taken along section B-B of the lower lever arm 76 of FIG. 5. Referring to FIG. 6, the deformation member 48 has an upper flange 80 which extends an upper flange height J from the base, at an angle δ. Referring to FIG. 7, the deformation member 52 has a lower flange 84 which extends a lower flange height K from the base at an angle φ. In one embodiment, the angles δ and φ are about equal, and the lower flange height K is greater than the upper flange height J. The flange height may be adjusted in order to increase or decrease the amount of force required to collapse the respective deformation cavity. For example, if it is desired that a relatively large force be required to collapse the deformation member, both the upper flange height and the lower flange height may be increased, resulting in a relatively large amount of force being required to collapse the deformation element. Similarly, it may be desired to have a first stage which collapses with relatively little force, and a second stage which collapses with a relatively large force. Such a configuration is utilized in the embodiment of FIGS. 5-7, where the lower flange height K is greater than the upper flange height J. This, combined with the shorter lever arms associated with the second deformation cavity, results in the second deformation cavity 36 requiring a greater amount of force to collapse than the first deformation cavity 32.

A deformation element may thus be designed with a very predictable performance, and may be designed to operate in various stages designed to collapse sequentially upon the application of a large enough force along an axis of deformation. Furthermore, a deformation element of the present invention may also be designed with more than two stages, or with only one stage. In an embodiment, two deformation members may be designed each having a single radius of curvature, such that when the members are interconnected, a single deformation cavity is present. A deformation element, in one embodiment, is designed with three deformation cavities, assembled from two deformation members each having a substantially identical shape and having a triple curve structure. Likewise, four or more stages could be used.

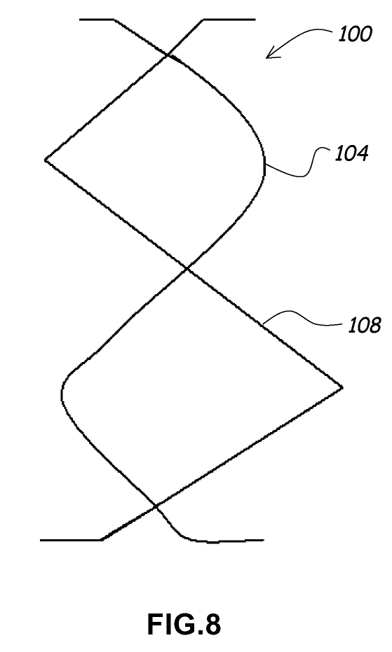

Similarly, each deformation element may have a different shape, with each member having interlocking engagement slots which are aligned. An example of such a deformation element 100 is illustrated in FIG. 8. In this embodiment, the deformation element 100 is formed from two interlocking deformation members 104, 108 which each have a different shape. Deformation member 104 has, in this embodiment, a curved shape. Deformation member 108 has, in this embodiment, a generally piecewise linear shape. Each of the deformation members 104, 108 include engagement slots which are approximately aligned in order to allow the deformation members 104, 108 to slidably interconnect. It will be understood that numerous other configurations are possible, with deformation elements having various shapes. For example, substantially different shapes of deformation members may be selected where packaging space is limited and one deformation member is designed having a different shape in order to fit in the limited space. Additionally, mounting schemes may require substantial differences in shape, bend angles, and hole patterns of deformation member mounting tabs.

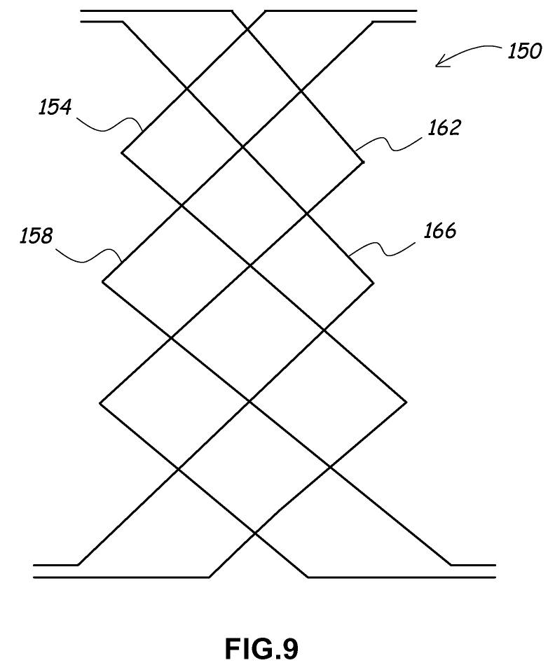

In another embodiment, more than two deformation members are used to form a deformation element. In this embodiment, illustrated in FIG. 9, a deformation element 150 is formed from four interlocking deformation members 154, 158, 162, and 166. Each of the deformation members 154, 158, 162, 166 include engagement slots which are approximately aligned in order to allow the deformation members 154, 158, 162, 166 to slidably interconnect and from deformation element 150. In this manner, numerous deformation cavities are present which are capable of collapsing in a concurrent or sequential manner, depending upon various factors similar to those described above.

Deformation elements as described herein are, in an embodiment, assembled from stamped steel deformation members, which provide predictable, repeatable, and reliable deformation characteristics, and are relatively straightforward to design and manufacture. Such an element may be used in a design having a short development cycle. Furthermore, the element is relatively inexpensive to manufacture, as the members are stamped, rather than extruded, and may be made of steel, rather than a more expensive material, such as aluminum. The elements, in embodiments where the shapes of the elements are substantially identical, may be stamped using a single form, rather than requiring more than one stamping form. Additionally, the weight of the deformation element of the present invention is not significantly greater than a deformation member formed from aluminum. The weight of the deformation element may be further reduced in an embodiment by forming holes in the deformation members in areas where the members will not be deformed. Namely, such holes may be made in the lever arm areas, which reduces weight and material costs while not significantly affecting deformation characteristics of the assembled deformation element.

While the cavities illustrated in the drawing figures are generally diamond shaped, other shapes may also be utilized. For example, other geometric shapes may include generally circular deformation cavities, generally hexagonal cavities, and generally octagonal cavities, to name a few.

In yet another embodiment, following the assembly of the deformation members into the deformation element, the deformation cavities may be filled with material. Such material may act to further absorb energy during an impact which deforms the deformation element. Such material may include, for example, foam, or other deformable material as required for a particular application in which the deformation element will be used.

A deformation member, as described herein and as will be readily apparent to one of skill in the art, provides a great deal of design flexibility. Variables such as material thickness, material width, material strength, flange or no flange, flange height, relative flange height in multiple cavity designs, flange angles, number of deformation cavities, and relative sizes and shapes of deformation cavities in combination with all of the previously mentioned variables allow for a very flexible and tunable design for a variety of energy absorption applications.

Furthermore, as is apparent from this design flexibility, a description of all of the possible deformation element designs is not practical. Accordingly, while the invention has been particularly shown and described with reference to a preferred embodiment thereof, it will be understood by those skilled in the art that various other changes in the form and details may be made without departing from the spirit and scope of the invention.

1. An energy absorbing structure, comprising:
a first deformation member having a curved shape with at least first and second opposing radii of curvature in the direction of a deformation axis; and
a second deformation member interconnected with said first deformation member such that said first and second deformation members intersect to define at least first and second deformation cavities between said deformation members, at least one of said deformation cavities operable to close during application of a load in the direction of said deformation axis.

2. The energy absorbing structure, as claimed in claim 1, wherein said first and second deformation members have a substantially identical shape.

3. The energy absorbing structure, as claimed in claim 1, wherein said first and second deformation members include a plurality of engagement slots, and wherein said engagement slots of said first deformation member slidably engage with said engagement slots of said second deformation member.

4. The energy absorbing structure, as claimed in claim 3, wherein said engagement slots are arranged to allow said first and second deformation members to substantially completely overlap.

5. The energy absorbing structure, as claimed in claim 1, wherein said first deformation cavity is operable to close upon the application of a first load in the direction of the deformation axis, and said first and second deformation cavities are operable to close upon the application of a second load in the direction of the deformation axis, wherein the second load is greater than the first load.

6. The energy absorbing structure, as claimed in claim 1, wherein said first and second deformation cavities are operable to close concurrently upon the application of a load.

7. The energy absorbing structure, as claimed in claim 1, wherein said first and second deformation members include a first flange along said first radius of curvature and a second flange along said second radius of curvature.

8. The energy absorbing structure, as claimed in claim 7, wherein a height of said first flange is greater than a height of said second flange.

9. The energy absorbing structure, as claimed in claim 8, wherein the height of said first and second flanges is selected based on load requirements for said deformation element.

10. The energy absorbing structure, as claimed in claim 1, wherein said first radius of curvature is greater than said second radius of curvature.

11. The energy absorbing structure, as claimed in claim 1, wherein said first radius of curvature is substantially equal to said second radius of curvature.

12. A deformation structure for use in a motor vehicle, comprising:
a first deformation member; and
a second deformation member, wherein said first and second deformation members are interconnected such that an intersection of the members creates first and second deformation cavities arranged along a deformation axis, said deformation cavities operable to collapse during energy absorption along said deformation axis.

13. The deformation structure for use in a motor vehicle, as claimed in claim 12, wherein said first and second deformation members include a plurality of engagement slots, and wherein said engagement slots of said first deformation member slidably engage with said engagement slots of said second deformation member.

14. The deformation structure for use in a motor vehicle, as claimed in claim 13, wherein said engagement slots are arranged to allow said first and second deformation members to substantially completely overlap.

15. The deformation structure for use in a motor vehicle, as claimed in claim 12, wherein the shape of said first and second deformation members is substantially identical.

16. The deformation structure for use in a motor vehicle, as claimed in claim 12, wherein said first deformation cavity is operable to close upon the application of a first load in the direction of the deformation axis, and said first and second deformation cavities are operable to close upon the application of a second load in the direction of the deformation axis, wherein the second load is greater than the first load.

17. The deformation structure for use in a motor vehicle, as claimed in claim 12, wherein said first and second deformation members include a first flange along a first curve and a second flange along a second curve.

18. The deformation structure for use in a motor vehicle, as claimed in claim 17, wherein a height of said first flange is greater than a height of said second flange.

19. The deformation structure for use in a motor vehicle, as claimed in claim 18, wherein the height of said first and second flanges is selected based on load requirements for said deformation element.

20. A deformation structure for use in a motor vehicle, comprising:
at least two deformation cavities having diamond-shaped cross sections formed by the intersection of two opposing deformation members, the deformation members having substantially identical shapes.

21. The deformation structure for use in a motor vehicle, as claimed in claim 20, wherein said two opposing deformation members include a plurality of engagement slots, and wherein said deformation member slidably engage with said engagement slots allowing said deformation members to substantially completely overlap.

22. The deformation structure for use in a motor vehicle, as claimed in claim 20, wherein said deformation structure includes a first deformation cavity and a second deformation cavity, and wherein said first deformation cavity is operable to close upon the application of a first load in the direction of a deformation axis, and said second deformation cavity is operable to close upon the application of a second load in the direction of the deformation axis, wherein the second load is greater than the first load.

23. The deformation structure for use in a motor vehicle, as claimed in claim 20, wherein said deformation members include at least first and second flanges arranged along a perimeter of said deformation cavities.

24. The deformation structure for use in a motor vehicle, as claimed in claim 23, wherein a height of said first flange is greater than a height of said second flange.

25. The deformation structure for use in a motor vehicle, as claimed in claim 24, wherein the height of said first and second flanges is selected based on load requirements for said deformation structure.

26. A deformation structure for use in a motor vehicle, comprising:
a first deformation member having a curved shape with at least first and second opposing radii of curvature in the direction of a deformation axis;
a second deformation member having a substantially identical shape as said first deformation member; and
means for interlocking said first and second deformation members to create at least first and second deformation cavities.

27. The deformation structure for use in a motor vehicle, as claimed in claim 26, wherein said means for interlocking include a plurality of engagement slots.

28. The deformation structure for use in a motor vehicle, as claimed in claim 26, wherein said first deformation cavity is larger than said second deformation cavity.

29. The deformation structure for use in a motor vehicle, as claimed in claim 26, wherein said first radius of curvature is greater than said second radius of curvature.

30. The deformation structure for use in a motor vehicle, as claimed in claim 26, wherein said first radius of curvature is substantially equal to said second radius of curvature.
